(19) United States
(12) Patent Application Publication
(10) Pub. No.: US 2008/0192059 A1
(43) Pub. Date: Aug. 14, 2008

(54) Multi-user display

(75) Inventor: Kevin Kennedy, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/704,523

(22) Filed: Feb. 9, 2007

(51) Int. Cl. G06F 13/00; G06F 3/048

(52) U.S. Cl. 345/537; 715/792; 715/759

(57) ABSTRACT

The sharing of data via a multi-user data sharing display device is described. One disclosed embodiment comprises a body, a display disposed on the body, a first data input disposed on the body, and a second input disposed on the body. The device also comprises a controller configured to divide the display into a plurality of workspaces comprising a first workspace and a second workspace, to display data received at the first data input in the first workspace, and to display data received at the second data input in the second workspace. In this manner, multiple users may display data, such as digital images, on a single display for sharing with other users.

### BACKGROUND

The sharing of photographic and other data stored on digital cameras, personal digital assistants, cellular phones, etc., poses various difficulties. For example, currently a mobile device user may share such data by first transferring the data to a computer, and then sharing the data by email, by uploading to a network server, etc. However, such sharing processes may take many user steps, and may be difficult to perform while a user is away from a home computer, for example, when on vacation, while at a restaurant, etc. Therefore, in these settings, photos are often shared by passing the mobile data storage device from person to person to view the photos on the device display. Due to the small size of such displays, it may be difficult for more than one or two people to simultaneously view a photograph.

Some mobile devices, such as cellular phones, may be equipped to send photographs and other such data to other devices over a cellular network. However, per transaction costs may be high for sending such data. Likewise, some mobile data storage devices equipped with wireless communications technologies such as Bluetooth (IEEE 802.15.1) and WiFi (IEEE 802.11x) may be configured to allow the sharing of data with other similarly-equipped devices. However, the generally small sizes of mobile device displays may limit the number of persons who can view the data on the receiving device, and therefore may reduce user satisfaction with the sharing experience.

### SUMMARY

Accordingly, the sharing of data via a multi-user data sharing display device is described below in the Detailed Description. For example, one embodiment of a multi-user display device includes a body, a display disposed on the body, a first data input disposed on the body, and a second input disposed on the body. The first data input and the second data input are each configured to receive data from data storage devices. The device also comprises a controller configured to divide the display into a plurality of workspaces comprising a first workspace and a second workspace, to display data received from the first data storage device in the first workspace, and to display data received from the second data storage device in the second workspace. In this manner, multiple users may display data, such as digital photographs, on a single display for sharing with others.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a perspective view of an embodiment of a multi-user display device.

FIG. 2 shows a block diagram of an embodiment of a multi-user display device.

FIG. 3 shows an embodiment of a display surface on a multi-user display device.

FIG. 4 shows another embodiment of a multi-user display device.

FIG. 5 shows a process flow of an embodiment of a method of displaying data on a multi-user display device.

### DETAILED DESCRIPTION

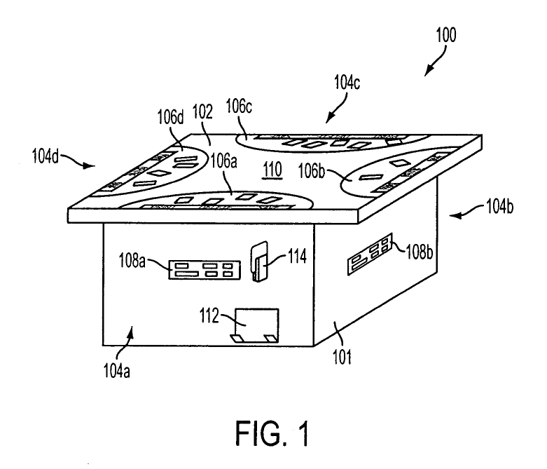

FIG. 1 shows an embodiment of a multi-user display device 100 configured to receive data from a plurality of users, and to display the data on a display surface viewable by a plurality of users. Data that may be shared via displaying on display device 100 may include, but is not limited to, photographic data, video data, music data, graphical data, documents, spreadsheets, presentations, multimedia, and any other suitable type of data. Display device 100 may also be configured to allow various operations to be performed on displayed data, including but not limited to editing, sending via email, transferring or uploading to other user's data storage devices, uploading to a network server, printing, ordering printed copies over a network, etc.

Display device 100 may be configured to receive data from any suitable type of data storage device. Examples of such data storage devices include, but are not limited to, devices with removable memory cards such as digital cameras, electronic devices with USB connectors or other cable connectors that allow data to be transferred via a cable to another device, memory devices such as flash drives, and devices with wireless data transfer capabilities. Specific examples of such devices include, but are not limited to, computing devices such as laptop computers, hand-held devices, cellular phones, portable media players, personal digital assistants, digital still image cameras, digital video-cameras, and other microprocessor-based or microcontroller-based programmable consumer electronics and/or appliances. As used herein, the term “computing device” may include any device that electronically executes one or more programs, and “data storage device” may include any device with a computer-readable storage medium capable of storing computer-readable data and/or other content. The embodiments described herein may be implemented on display device 100 and other such computing devices, for example, via computer-executable instructions or code, such as programs, stored on a computer-readable storage medium and executed by the computing device. Generally, programs include routines, objects, components, data structures, and the like that perform particular tasks or implement particular abstract data types. The term “program” as used herein may connote a single program or multiple programs acting in concert, and may be used to denote applications, services, or any other type or class of program.

Continuing with FIG. 1, the depicted display device 100 comprises a body 101 supporting a horizontal table-like top surface having a display screen 102. Display device 100 further comprises a plurality of workstations, indicated generally at 104a, 104b, 104c and 104d. Each workstation 104a-d comprises an associated personal workspace 106a, 106b, 106c and 106d on display screen 102, and also a data input station, two of which 108a and 108b are visible in FIG. 1. Further, display screen 102 also comprises a shared workspace 110 into which photographs or other data can be moved for sharing. Various embodiments of personal workspaces 106a-d and shared workspace 110 are described in more detail below. Further, display device 100 may include other structures, such as a print output 112 to output prints from an internal printing device, and/or a payment input 114, such as a debit/credit/prepaid card reader. While described herein in the context of a display device having a horizontal, table-like display surface, it will be appreciated that display device 100 may include a display having any other suitable orientation, including vertical and diagonal orientations, as described in more detail below.

Each input station 108a-d includes one or more data input devices such as memory card readers, flash drive readers, USB ports, other cable connectors, etc. A user may transfer photographs or other data to display device 100 by connecting a data storage device containing the photographs or other data to an input at one of the input stations, for example, input station 108a. Upon connecting a data storage device to input station 108a, display device 100 downloads data stored on the data storage device and displays the data in the associated personal workspace 106a on display 102. Other users may similarly download and display data at each of the other input stations 108b-d such that each user of display device 100 can share data with all other users of display device 100, and also can view the data downloaded onto display device 100 by all other users. In this manner, images and other data may be shared by a group of users in a simple and intuitive manner. It will be understood that inputs from different input stations may be located either physically close together or spaced apart on body 101, but that image data downloaded from different input stations will be displayed initially in different regions of display 102.

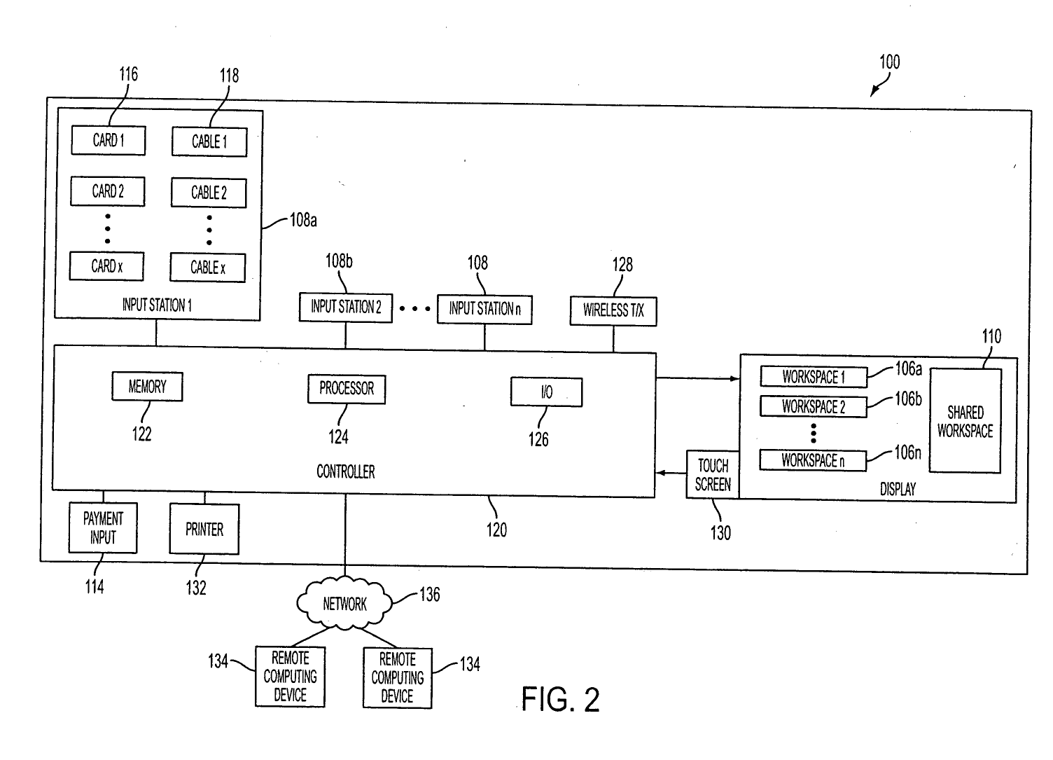

While display device 100 as depicted has four workstations 104 (one for each side of body 101) configured to display the data of up to four users seated or standing around display device 100, it will be appreciated that display device 100 may have any other suitable number of workstations 104. This generalized in FIG. 2, which shows n workspaces 106 and input stations 108 (wherein n≧2). Further, each input station 108 may have any suitable number and/or type of inputs. For example, as depicted in FIG. 2, each input station 108 may comprise x card readers 116 and y cable connectors 118 (wherein x and y≧0, and x+y≧1). The use of multiple card readers 116 and/or multiple cable connectors 118 at each input station 108 may allow memory devices of different types, brands and/or formats to be supported by display device 100.

Continuing with FIG. 2, display device 100 comprises an electronic controller 120 including memory 122, a processor 124 and input/output system 126. Controller 120 is configured to receive data at input stations 108 and to display the data in the associated workspaces. Further, display device 100 may comprise a wireless transmitter and receiver 128. Wireless transmitter and receiver 128 may allow data to be transferred from a data storage device to display device 100 over a wireless connection, rather than via a physical connection to one of input stations 108. In this manner, photographs stored on wireless communication-enabled cameras, telephones, and other data storage devices may be wirelessly transferred to display device 100 for display without connecting a memory card, flash drive or cable to display device 100.

Display device may further comprise a touch screen input 130. Touch screen input 130 may allow users to move photographs and other data between personal workspaces 106 and shared workspace 110 by touching the screen over the desired image and then dragging the image to a desired destination. Furthermore, touch screen input 130 may allow users to perform simple editing and image processing operations. For example, in one embodiment, a user may enlarge an image in shared workspace 110 by touching a corner of the image and then dragging it outwardly. Likewise, a user may change an aspect ratio of an image by touching a side of the image and then dragging the side outwardly, and/or may rotate an image by making a rotational motion with one or more fingers on the screen. Further, a user may be able to mark up an image via making drawing motions on touch screen input 130. Display device 100 may further be configured to allow a user to save an edited image by dragging the edited image from shared workspace 110 into a personal workspace 106, and/or by selecting an appropriate command in an on-screen menu, off-screen control, or other input device.

Any suitable touch-screen mechanism may be used as touch screen input 130. Examples include, but are not limited to, capacitive, resistive, and optical touch sensing mechanisms. Further, in some embodiments, touch screen input 130 may be a multi-touch system capable of receiving and processing multiple inputs at one time, thereby allowing multiple users to manipulate images at one time. Additionally and/or alternatively, display device 100 may include other inputs than touch screen input 130. Examples may include, but are not limited to, input buttons (not shown) arranged around or to the side of display 100.

Continuing with FIG. 2, display device 100 may further comprise a printing device such as a printer 132. This may allow a user to print an image displayed in shared workspace 110 or one of personal workspaces 106. Further, as described above, if it is desired to charge a fee for services provided by display device 100, display device 100 may further include one or more payment inputs 114. It will be appreciated that payment input 114 may be configured to accept any suitable type of payment, including but not limited to payments via debit cards, credit cards, cash, pre-paid cards, gift cards, hotel room keycards, magnetically coded cards, radiofrequency identification (RFID) cards, or any other detectable object or item which can link a user to a payment account.

Display device 100 may be connected to external computing devices 134 via a network 136, which may be a local area network, a wide area network, or any other suitable network or group of networks. This may allow display device 100 to communicate with other remote computing devices to enable various user-requested transactions to be conducted with the remote devices. For example, payment via payment input 114 may be processed over network 136 at a remote payment processing site. Additionally, in some embodiments, display device 100 may allow a user to send an image displayed on display 102 to a recipient via email over network 136. Also, in some embodiments, display device 100 may be configured to allow a user to convert an image into a postcard format, signed by the user via touch screen input 130, for emailing or printing by the user. Further, display device 100 may be configured to allow a user to order prints of a photograph, a scrapbook containing multiple photographs, and the like, from a remote vendor via network 136. It will be appreciated that these are merely examples of transactions that may be conducted over network 136, and that display device 100 may be configured to conduct any other suitable transaction over network 136.

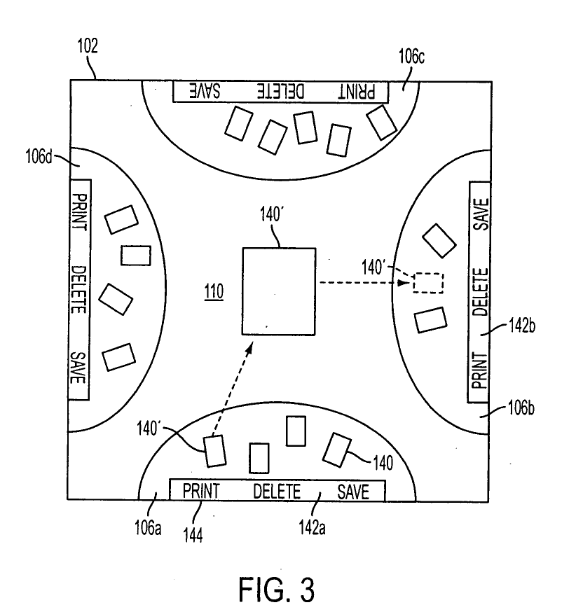

FIG. 3 shows an example of a suitable layout of personal workspaces 106a-d and shared workspace 110 on display screen 102. Each personal workspace 106 comprises a section of display screen 102 located adjacent to an edge of display screen 102, and shared workspace 110 occupies a central portion of display screen 102. Alternatively, personal workspaces 106 and shared workspace 110 may have any other suitable spatial arrangement relative to one another. Each personal workspace 106a-d is shown as containing a plurality of items of data 140, such as still or video images, displayed within the personal workspace 106. Items of data 140 within each personal workspace 106a-d are shown in FIG. 3 to be oriented in orientations easily viewable by a user located at the corresponding workstations 104a-d. However, it will be appreciated that items of data 140 may have any suitable orientation or orientations within personal workspaces 106a-d.

In some embodiments, each personal workspace 106a-d may include a menu of functions that may be performed on data displayed within the personal workspace. In the depicted embodiment, each personal workspace 106a-d includes its own menu, depicted at 142a-d. Menus 142a-d are depicted as being located adjacent an edge of display 102, but it will be appreciated that each of menus 142a-d may be located in any suitable location on display 102. Menus 142a-d as depicted include items that may be selected by a user via touch screen input 130 to cause display device 100 to perform the operation represented by the menu item. For example, in the depicted embodiment, a user may print a photo shown within a personal workspace 106a-d or shared workspace 110 by first selecting via touch screen input 130 the item or items of data to be printed, and then selecting the “print” command 144. The device may begin printing upon receipt of this command, or may prompt the user for payment and begin printing only upon receipt of payment via payment input 114. In an alternative embodiment, each workstation 104a-d includes, instead of or in addition to touch screen input 130, input buttons (not shown) that allow a user to request operations to be performed on selected data.

In the embodiment of FIG. 3, each menu 142a-d includes “print”, “delete” and “save” commands. However, it will be appreciated that these commands are shown merely for the purpose of example, and that menu 142 may include any suitable list of commands. Furthermore, while shown as a bar-shaped region adjacent to the edge of display 102, it will be appreciated that menu 142 may take any other suitable form. Additionally, menu 142 may either be continuously visible, or may be “hidden” until occurrence of an event that triggers the visibility of the menu, such as a user selecting an item or items of data within a personal workspace on which to perform an operation, moving an item of data from shared workspace 110 into a personal workspace 106, touching display 102 in a region near the location of menu 142, etc.

Continuing with FIG. 3, movement of an image 140′ from personal workspace 106a into shared workspace 110 is shown schematically via a dashed-line arrow. As depicted, image 140′ may be automatically enlarged as it is moved into shared workspace 110. Likewise, where the data is being shared is video or audio data, moving an image or icon representing such data into shared workspace 110 may cause the video, audio or multimedia data to be played. While only a single image is shown in FIG. 3 as being located in shared workspace 110, it will be appreciated that display device 110 may be configured to allow multiple images to be displayed within shared workspace 110.

FIG. 3 also illustrates the movement of image 140′ from shared workspace 110 into personal workspace 106b. This may be performed, for example, where a user occupying workstation 104b wishes to save a photograph of a user occupying workstation 104a. In some embodiments, movement of image 140′ into personal workspace 106b may cause image 140′ to be saved automatically to a data storage device connected to input station 108b. In other embodiments, image 140′ is saved after a user moves image 140′ into personal workspace 106b and selects a “save” command from menu 142b in personal workspace 106b. In yet other embodiments, a user may be prompted to save image 140′ upon disconnecting a data storage device from input station 108b. In these embodiments, if a user elects to save the item of data represented by the image, display device 100 may display a message requesting the user to reconnect the data storage device to input station 108b so that the image or item of data represented by the image may be saved on the data storage device. If the user elects not to save the image, any copies of that user's data that was downloaded and cached on display device 100 may be cleared from memory to prevent a later user from accessing the earlier user's data.

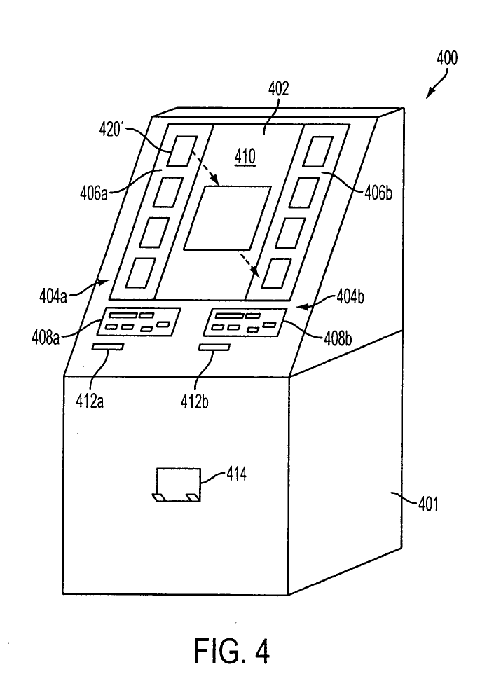

As mentioned above, a multi-user display device may have other configurations than that shown in FIG. 1. FIG. 4 shows another example of a multi-user display device 400 having a body 401 that supports a diagonally oriented display screen 402. Display device 400 comprises two workstations 404a, 404b. Workstation 404a comprises a first personal workspace 406a on display 402, and a first input station 408a. Likewise, workstation 404b comprises a second personal workspace 406b on display 402, and a second input station 408. Display 402 also may comprise a shared workspace 410. Further, display device 400 as depicted comprises one or more payment inputs 412a-b, and a print output 414. It will be appreciated that, in some embodiments, display device 400 may include only first and second personal workspaces 406a-b and not a shared workspace 410.

Display device 400, as well as display devices 100 and 200, may be used in any suitable use environment. For example, these display devices may be used as a walk-up photograph/video/other data sharing kiosk which may be deployed in resorts, hotels, restaurants, theme parks, and other such places where customers often take pictures and may wish to share pictures. In the depicted embodiment, two users may share photographs or other data by connecting data storage devices (such as a memory card from a digital camera) to connectors such as memory card readers or cable connectors at input stations 408a and 408b. Display device 400 reads the data storage devices, displays data received at input station 408a in workspace 406a, and displays data received at input station 408b in workspace 406b. Further, display device 400 may be configured to allow users to move images, such as image 420′, into shared workspace 410 and/or between personal workspaces 406a-b. In this manner, users may copy data files onto each other's data storage devices. Further, as described above, display device 400 may permit simple editing functions to be performed on photographs and then saved onto either user's data storage devices. Additionally, display device 400 may be connected to a network to allow photographs or other data to be sent to remote devices or recipients, for example, via email.

To allow users to request the execution of such operations, display 402 may include a touch-screen input, and various menus (not shown) allowing the selection of these operations may be displayed on display 402. Additionally and/or alternatively, one or more button inputs (not shown) may be provided on body 401 to allow a user to select operations to perform on the data displayed on display 402.

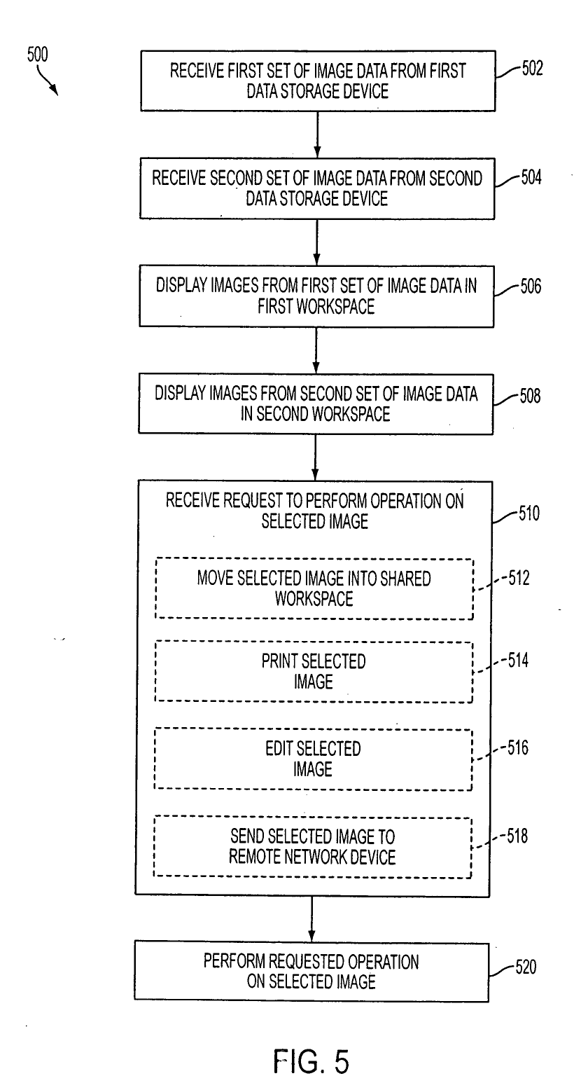

FIG. 5 shows a flow diagram of a method 500 for sharing data via a multi-user display device, such as devices 100, 200 and 400. Method 500 is shown in the context of the sharing of image data, but it will be appreciated that method 500 may be used to share any other suitable type of data. Method 500 first comprises, at 502, receiving a first set of image data from a first data storage device connected a first input, and, at 504, receiving a second set of image data from a second data storage device connected to a second input. The image data received at 502 and 504 may be received via any suitable data connection or data transfer device, including but not limited to a memory card reader, a cable connector such as a USB cable connector, a wireless connection such as an 802.11x, RFID or Bluetooth connection, etc.

Next, method 500 comprises, at 506, displaying the image data received from the first data storage device in a first workspace on a display, and, at 508, displaying image data received from the second data storage device in a second workspace on the display. The first and second workspace may be located at any suitable location and in any suitable orientation on the display, including but not limited to those disclosed above.

Method 500 further comprises, at 510, receiving an input from a user requesting an operation to be performed on a selected image or images displayed on the display. The requested operation may be any suitable operation. For example, the user may request one or more selected images to be moved from the first or second workspace into the shared workspace, as indicated at 512. Also, the user may request one or more selected images to be printed via an on-board or remote printing device, as indicated at 514. Furthermore, the user may request edits to be made to the image, as indicated at 516. Examples of edits that may be made include, but are not limited to, resizing, cropping, changing of an aspect ratio of an image, annotating the image, reducing redeye, changing or correcting color, and other such image editing. Additionally, the user may request one or more selected images to be sent to a remote device via a network connection, as indicated at 518. For example, a user may request for one or more images to be sent to a recipient via email, to be uploaded to a network server for viewing on a web page, etc. Other operations than those shown in FIG. 5 that may be performed include, but are not limited to, the deletion of selected images from a data storage device, various image editing or processing operations such as color adjustments, redeye correction, image cropping and/or resizing, etc.

Upon receiving the request to perform the operation on the selected image or images, method 520 comprises performing the requested operation. After performing the operation, the display device may receive additional requests to perform operations, or may detect the disconnection of a data storage device. Upon disconnection of a data storage device, the display device may automatically clear from memory all contents downloaded from that data storage device, or may display a message to the user requesting confirmation that the user desires to terminate the session and/or requesting the user to reconnect the data storage device so that edits or changes to images, and additions or deletions of images, may be saved to the data storage device.

While disclosed herein in the context of the sharing of image data, it will be appreciated that a multi-user display device such as those disclosed herein may be used to share any other suitable type of data, including but not limited to music or other audio data, documents, spreadsheets, presentations, etc. Further, it will be appreciated that the specific display device configurations shown and described herein are set forth for the purpose of example, and that these specific embodiments or examples are not to be considered in a limiting sense, because numerous variations are possible. The subject matter of the present disclosure includes all novel and nonobvious combinations and subcombinations of the various processes, systems and configurations, and other features, functions, acts, and/or properties disclosed herein, as well as any and all equivalents thereof.

1. A multi-user electronic display device, comprising:
a body;
a display disposed on the body;
a first data input disposed on the body and configured to receive data from a first data storage device;
a second data input disposed on the body and configured to receive data from a second data storage device; and
a controller configured to divide the display into a plurality of workspaces comprising a first workspace and a second workspace, to display data received from the first data storage device in the first workspace, and to display data received from the second data storage device in the second workspace.

2. The device of claim 1, wherein the display comprises a generally horizontal orientation with an upwardly facing viewing surface.

3. The device of claim 1, wherein the display has a generally vertical or diagonal orientation.

4. The device of claim 1, wherein the first data input and the second data input each comprises one or more of a memory card reader and a cable connector.

5. The device of claim 1, wherein the plurality of workspaces further comprises a shared workspace disposed adjacent to the first and second workspaces, and wherein the controller is configured to move data between the first and second workspaces and the shared workspace upon receipt of a user input requesting such movement.

6. The device of claim 5, wherein the data are image data, and wherein the controller is configured to display the image data in the shared workspace in an enlarged format relative to image data displayed in the first workspace and the second workspace.

7. The device of claim 1, further comprising a wireless transmitter and receiver.

8. The device of claim 1, wherein the controller is configured to receive an input requesting an operation to be performed on a selected item of data, and to perform the operation on the selected item of data.

9. The device of claim 8, wherein the requested operation comprises one or more of a request to move the selected item of data to a shared workspace on the display, to edit the selected item of data, to print the selected item of data, and to send the selected item of data to a recipient over a network.

10. A multi-user data sharing display device, comprising:
a display;
a first workstation comprising a first workspace on the display and a first memory card reader;
a second workstation comprising a second workspace on the display and a second memory card reader; and
a controller configured to receive data from a first memory card connected to the first memory card reader and from a second memory card connected to the second data memory card reader, and to display the data received from the first memory card in the first workspace and the data received from the second memory card in the second workspace.

11. The device of claim 10, further comprising a wireless transmitter and receiver.

12. The device of claim 10, further comprising a body on which the display, the first memory card reader and the second memory card reader are disposed.

13. The device of claim 12, wherein the display comprises a display surface disposed in a generally horizontal upwardly facing orientation.

14. The device of claim 12, wherein the display comprises a display surface disposed in a generally vertical or diagonal orientation.

15. The device of claim 10, further comprising a shared workspace disposed on the display adjacent to the first workspace and the second workspace.

16. The device of claim 10, wherein the controller is configured to receive an input requesting an operation to be performed on a selected item of data, and to perform the operation on the selected item of data.

17. The device of claim 10, wherein the display comprises a touch-screen input.

18. On an interactive display device comprising a display, a method of sharing image data, the method comprising:
receiving a first set of image data from the first data storage device;
receiving a second set of image data from the second data storage device;
displaying image data from the first set of image data on a first section of the display; and
displaying image data from the second set of image data on a second section of the display.

19. The method of claim 18, further comprising receiving a request from a user to perform an operation on image data displayed on the display, and performing the requested operation.

20. The method of claim 19, wherein the operation comprises one or more of moving an image into a third section of the display, printing a selected image, editing a selected image, and sending selected a selected image to a recipient over a network.
